(19) United States
(12) Patent Application Publication
(10) Pub. No.: US 2008/0259183 A1
(43) Pub. Date: Oct. 23, 2008

(54) Photo-vend

(76) Inventor: David Edward Hunter, Utiva, NY (US)

Correspondence Address: David Hunter, 24 Emerson Ave, Utica, NY, 13501-5622, US

(21) Appl. No.: 11/728,603

(22) Filed: Apr. 23, 2007

(51) Int. Cl. H04N 5/76

(52) U.S. Cl. 348/231.7

(57) ABSTRACT

The PHOTO_VEND is a digital photo vending machine. For a fee it will download a digital photograph onto the patrons storage medium.

The PHOTO_VEND can offer another medium for a person to sell their photographs. The photos can be downloaded onto CD OR CHIP.

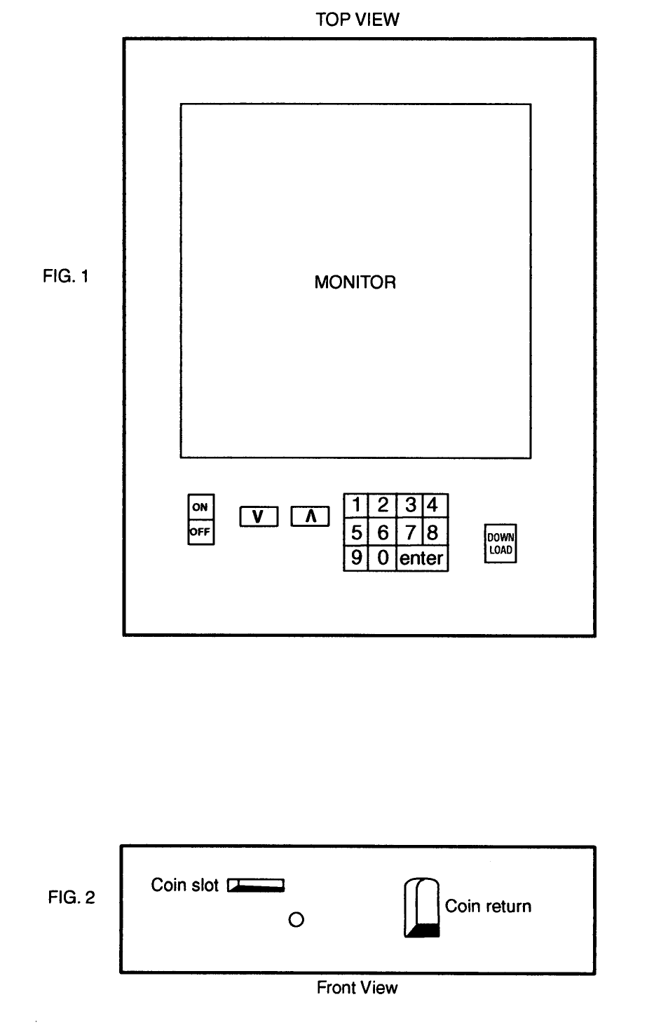

FIG. 1 Figure one illustrates the top of the machine as seen from standing over it looking down. It contains the monitor for viewing the photographs and the controls for selecting the photograph to purchase.

FIG. 2 Figure two contains the coin slot and coin return to be used by the customer if they decide to purchase a photograph.

I claim:

1. The concept of a digital photo vending machine. The photos are stored digitaly and downloaded digitaly onto a storage medium such as a CD or chip
